(19) United States
(12) Patent Application Publication
(10) Pub. No.: US 2026/0202241 A1
(43) Pub. Date: Jul. 16, 2026

(54) UNMANNED AERIAL VEHICLE BASED ABNORMAL NOISE DETECTION DEVICE AND OPERATING METHOD THEREOF

(71) Applicant: SAMSUNG ELECTRONICS CO., LTD., Suwon-si (KR)

(72) Inventors: Jae Hyun LEE, Seoul-si (KR); Jong Ho PAIK, Seoul-si (KR); Jae-Sang YUN, Suwon-si (KR); Seung Gyu KIM, Suwon-si (KR); Su-Hyoung CHO, Suwon-si (KR)

(73) Assignees: SAMSUNG ELECTRONICS CO., LTD., Suwon-si (KR); LOAS Inc., Seoul-si (KR)

(21) Appl. No.: 19/447,121

(22) Filed: Jan. 13, 2026

(30) Foreign Application Priority Data
Jan. 15, 2025 (KR) 10-2025-0006212

(51) Int. Cl. G01H 17/00; G06T 7/70

(52) U.S. Cl. CPC G01H 17/00; G06T 7/70

(57) ABSTRACT

A method for operating an unmanned aerial vehicle based abnormal noise detection device includes capturing, using a camera attached to a drone to generate image data, an image of a measurement target included in the image data; generating, based on the captured image, a matrix comprising a plurality of cells on the image data; generating object data of an object corresponding to the measurement target included in the image data, the object data indicating a size and a position of the object that is a target of an abnormal noise detection; collecting, using an acoustic sensor attached to the drone, acoustic data corresponding to each of the cells; classifying, using the collected acoustic data, abnormal acoustic data depending on a frequency of the acoustic data; generating filtered abnormal acoustic data using the abnormal acoustic data and the object data; and generating a visualized image in which positions of cells including the filtered abnormal acoustic data are displayed on the image data.

### CROSS-REFERENCE TO RELATED APPLICATION

This application claims priority from Korean Patent Application No. 10-2025-0006212 filed on Jan. 15, 2025 in the Korean Intellectual Property Office and all the benefits accruing therefrom under 35 U.S.C. § 119, the contents of which in its entirety are herein incorporated by reference.

### BACKGROUND

The present disclosure relates to an unmanned aerial vehicle based abnormal noise detection device and an operating method thereof.

An acoustic camera is an advanced apparatus that visualizes and utilizes sound, and is a new technology apparatus used in various fields such as multimedia information and communication devices, home appliances, automobiles, and construction.

A microphone array beamformer is one of noise source location methods, which measures sound waves generated at the noise source by the use of a plurality of microphone sensors, and may visualize the distribution of the noise source to easily determine through signal processing on the measured sound waves. A method is used in which the signal is reconstructed into a signal generated at a specific transmission position according to characteristics of signal received by a microphone, a sound pressure level thereof is measured, and the measured sound pressure level is displayed as a spatial distribution to estimate the position of the noise source. The measurement technique of the acoustic camera has an advantage of being able to intuitively check the distribution of the noise source, and is being extended and applied to utilization at the research and development stages of various industrial fields. Currently, a method for detecting abnormal noise in high-altitude industrial facilities detects abnormal noise by detecting only sounds in a specific frequency band, and does not disclose using an unmanned aerial vehicle based noise detection device.

### SUMMARY

Aspects of the present disclosure provide an operating method of an unmanned aerial vehicle based abnormal noise detection device capable of detecting abnormal noise in facilities that are difficult to access.

Aspects of the present disclosure also provide an unmanned aerial vehicle based abnormal noise detection device capable of detecting abnormal noise in facilities that are difficult to access.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

Specific matters of other embodiments are included in the detailed description and drawings.

According to an aspect of the disclosure, a method for operating an unmanned aerial vehicle based abnormal noise detection device includes capturing, using a camera attached to a drone to generate image data, an image of a measurement target included in the image data; generating, based on the captured image, a matrix comprising a plurality of cells on the image data; generating object data of an object corresponding to the measurement target included in the image data, the object data indicating a size and a position of the object that is a target of an abnormal noise detection; collecting, using an acoustic sensor attached to the drone, acoustic data corresponding to each of the cells; classifying, using the collected acoustic data, abnormal acoustic data depending on a frequency of the acoustic data; generating filtered abnormal acoustic data using the abnormal acoustic data and the object data; and generating a visualized image in which positions of cells including the filtered abnormal acoustic data are displayed on the image data.

According to an aspect of the disclosure, an unmanned aerial vehicle based abnormal noise detection device includes a drone; an acoustic sensor attached to the drone and configured to collect acoustic data using a beam-forming technology; a camera attached to the acoustic sensor, the camera configured generate image data that includes an image of a measurement target; a controller which generates a visualized image, using image data and the acoustic data; and a display which displays the visualized image, in which the controller is configured to: generate a matrix including a plurality of cells on the image data and larger than or equal to the size of the image data, generate object data of an object corresponding to the measurement target included in the image data, the object data indicating a size and a position of the object that is a target of an abnormal noise detection, classify acoustic data that is not included in a preset first frequency band range from the acoustic data corresponding to each cell to generate abnormal acoustic data, generate, using the abnormal acoustic data and the object data, filtered abnormal acoustic data, and generate a visualized image in which positions of cells including the filtered abnormal acoustic data are displayed on the image data, in which the first frequency band range is a range of the acoustic data measured during normal operation of the object.

According to an aspect of the disclosure, a method for operating an unmanned aerial vehicle based abnormal noise detection device, includes capturing, to generate image data with a camera attached to a drone, an image of a measurement target included in the image data; generating, based on the captured image, a matrix including a plurality of cells on the image data and corresponding to a size of the image data; generating object data of an object corresponding to the measurement target included in the image data, the object data indicating a size and a position of the object that is a target of an abnormal noise detection; collecting acoustic data corresponding to each of the cells by an acoustic sensor attached to the drone; classifying, using the collected acoustic data, acoustic data that is not included in a preset first frequency band range from the acoustic data to generate abnormal acoustic data; removing noise that is not abnormal acoustic data due to an abnormal state of the object from the abnormal acoustic data to generate filtered abnormal acoustic data; generating visualized image in which the positions of cells that include the filtered abnormal acoustic data are displayed in the image data; providing the visualized image to a display by a radio communication module; and displaying the visualized image by the display.

### BRIEF DESCRIPTION OF DRAWINGS

FIG. 1 is a diagram of an unmanned aerial vehicle based abnormal noise detection device according to some embodiments of the present disclosure.

FIG. 2 is a diagram showing an acoustic sensor of the unmanned aerial vehicle based abnormal noise detection device according to some embodiments of the present disclosure.

FIG. 3 is a diagram of a controller of the unmanned aerial vehicle according to some embodiments of the present disclosure.

FIG. 4 is a diagram of a display of the unmanned aerial vehicle based abnormal noise detection device according to some embodiments of the present disclosure.

FIG. 5 is a flowchart illustrating operation of the unmanned aerial vehicle based abnormal noise detection device according to some embodiments of the present disclosure.

FIG. 6 is a flowchart illustrating a visualized image generation process of FIG. 5 according to some embodiments of the present disclosure.

FIG. 7 illustrates a diagram of a leakage detection operation for region A of FIG. 6.

### DETAILED DESCRIPTION OF EMBODIMENTS

Hereinafter, embodiments of the present disclosure will be described with reference to the accompanying drawings. The same reference numerals are used for the same components on the drawings, and the repeated description thereof will not be provided.

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and B,” “at least one of A or B,” or “one or more of A and/or B” and the like may include all possible combinations of the listed items. For example, “A or B,” “at least one of A and B,” or “at least one of A or B” may refer to all of the following cases: (1) including A, (2) including B, or (3) including A and B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that an apparatus is “specifically designed to” in terms of hardware.

Instead, under some circumstances, the expression “an apparatus configured to” may mean that the apparatus “is capable of” performing an operation together with another apparatus or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Further, in the embodiments of the disclosure, ‘a module’ or ‘a part’ may perform at least one function or operation, and may be implemented as hardware or software, or as a combination of hardware and software. Also, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

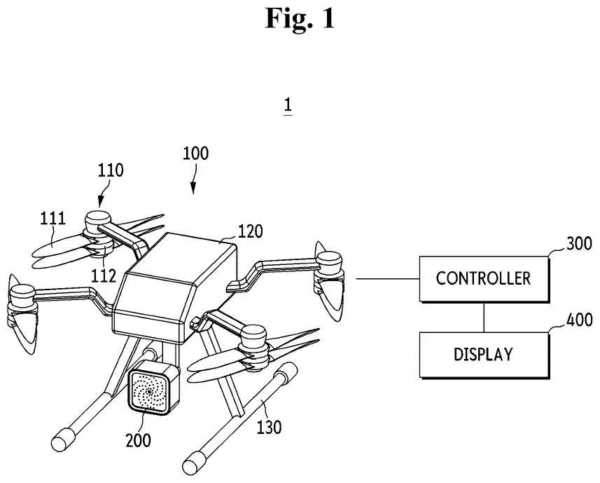

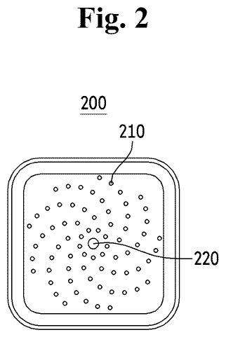

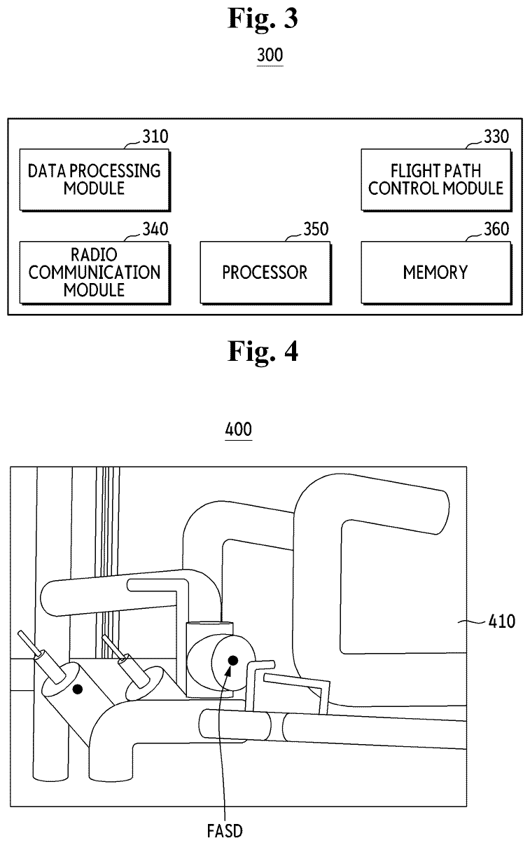

FIG. 1 is a diagram for explaining an unmanned aerial vehicle based abnormal noise detection device according to some embodiments of the present disclosure. FIG. 2 is a diagram showing an acoustic sensor of the unmanned aerial vehicle based abnormal noise detection device according to some embodiments of the present disclosure. FIG. 3 is a diagram for explaining a controller of the unmanned aerial vehicle based abnormal noise detection device according to some embodiments of the present disclosure. FIG. 4 is a diagram for explaining a display of the unmanned aerial vehicle based abnormal noise detection device according to some embodiments of the present disclosure.

Referring to FIGS. 1 to 4, the unmanned aerial vehicle based abnormal noise detection device 1 includes a drone 100, an acoustic sensor 200, a controller 300, and a display 400. In one or more examples, the drone 100 includes the acoustic sensor 200, controller 300, and display 400 are attached to the drone. In one or more examples, the drone 100 includes the acoustic sensor 200 and controller 300, and the display 400 is remotely located from the drone 100. When the display 400 is remotely located from the drone 100, the display 400 may be controller separately by a different controller that is in communication with the controller 300.

The drone 100 may include an operation propulsion device 110, a main body 120, landing legs 130, and a connecting unit.

The operation propulsion device 110 may be provided in plurality. The operation propulsion devices 110 may be connected to the main body 120 and disposed to be spaced apart from each other. The operation propulsion device 110 may include a propeller 111 and a motor 112. The propeller 111 may be connected vertically to the main body 120.

The plurality of propeller support units may be formed radially on the main body 120. A pair of propellers 111 and a pair of motors 112 may be disposed on each propeller support unit. That is, even if any one of the pair of motors 112 is not operating, the other motor may operate to operate the drone normally.

The plurality of propellers 111 may be disposed symmetrically around the center of the main body 120. The plurality of propellers 111 may rotate in a clockwise or counterclockwise direction. In one or more examples, a rotation direction of the motor 112 may be determined so that a rotation direction of the propellers 111 is a combination of the clockwise and counterclockwise directions. The rotation directions of the pair of propellers 111 symmetrical around the center of the main body 120 may be set equally. The rotation directions of the other pair of propellers 111 may be opposite. For example, one pair of opposing propellers 111 may rotate in a clockwise direction, and the other pair of opposing propellers 111 may rotate in a counterclockwise direction.

The landing legs 130 may be disposed to be spaced apart from each other on a bottom surface of the main body 120. In one or more examples, a shock-absorbing support member which minimizes the impact caused by the collision with the ground when the drone 100 lands may be mounted below the landing legs 130.

The connecting unit may be disposed below the main body 120. The connecting unit may connect the acoustic sensor 200 and the drone 100. The connecting unit may fix the acoustic sensor 200 to the drone 100. The connecting unit may include a fixing device so that the acoustic sensor 200 may be stably fixed while the drone 100 is operating.

The acoustic sensor 200 may be connected to the connecting unit. The acoustic sensor 200 may be attached to and detachable from the connecting unit. The acoustic sensor 200 may be fixed to the drone 100 through the connecting unit. The acoustic sensor 200 may be configured to detect, measure, and analyze sound waves in various mediums, including air, water, or solids. These sensors convert sound waves into electrical signals, allowing for the detection and interpretation of acoustic signals.

The acoustic sensor 200 may include a microphone array 210 and a camera 220. In one or more examples, the acoustic sensor 200 may be provided with lighting to help the camera 220 capture an image of a measurement target. The lighting may emit light to help the camera 220 capture an image of the measurement target in a dark peripheral environment.

The microphone array 210 may include a plurality of microphones. For example, the microphone array 210 may include 72 microphones. The form of the array in which the plurality of microphones are disposed may be modified in various ways according to the embodiment. For example, the microphones may be disposed radially around the center of the acoustic sensor 200. As another example, the array may be disposed spirally. The microphone array 210 may measure a sound pressure level of the sound sensed from the measurement target.

The camera 220 may capture the measurement target in which the acoustic sensor 200 detects sound. Although the camera 220 is shown to be disposed at the center of the acoustic sensor 200, the embodiment is not limited thereto. For example, a plurality of cameras 220 may be disposed at the edge of the acoustic sensor 200.

The acoustic sensor 200 may detect sound, using a beam-forming technology. For example, an array of antennas may be used to focus radio waves in a specific direction by adjusting the phase and amplitude of the signals transmitted by each antenna element, creating a concentrated beam of radio energy. This technique can improve signal strength, range, and data rates, while reducing interference in wireless communication systems. The acoustic sensor 200 may measure the sound pressure level of the sound sensed from the measurement target, and transmit it to the controller 300.

The beam-forming technology refers to a technology that may calculate the intensity distribution of sound on space through signal processing using a phase difference between a point on which sound is generated and the measurement signal due to the distance difference between the measurement sensors, and may estimate the position of the sound depending on its strength. The acoustic sensor 200 may generate acoustic data in consideration of the sound pressure level detected by the plurality of microphones of the microphone array 210 and the arrangement positions of the plurality of microphones. Specifically, the acoustic sensor 200 may generate acoustic data by comprehensively considering the sound pressure level detected by the plurality of microphones and the position at which the sound is generated. Therefore, the acoustic data may include the sound pressure level of the detected sound, and the position information at which the sound is generated.

The controller 300 may perform the overall control the operation of the unmanned aerial vehicle based abnormal noise detection device 1. The controller 300 may include a data processing module 310, a machine learning module 320, a flight path control module 330, a radio communication module 340, a processor 350, and a memory 360.

The data processing module 310 may generate a visualized image. For example, the data processing module 310 may generate the visualized image 410, using the acoustic data generated by the acoustic sensor 200 and the image data IMG captured by the camera 220. Alternatively, the data processing module 310 may generate the visualized image 410, by displaying the acoustic data generated by the acoustic sensor 200 on a rendering image representing a measurement target in which the sound pressure level is measured by the acoustic sensor 200.

Specifically, the data processing module 310 may classify acoustic data that is not included in a preset first frequency band range among the acoustic data transmitted from the acoustic sensor 200 as abnormal acoustic data, and filter noise included in the abnormal acoustic data to generate filtered abnormal acoustic data. Further, a visualized image in which the position of the filtered abnormal acoustic data is displayed on the image data may be generated.

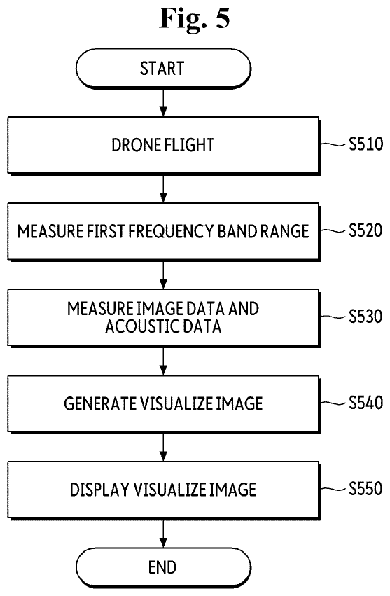

A method by which the data processing module 310 generates the visualized image will be described in detail with reference to FIGS. 5 to 7.

In some embodiments, the first frequency band range may be a frequency band range of acoustic data collected by the acoustic sensor 200 when no abnormal noise occurs in the measurement target. That is, the first frequency band range may be a frequency band range measured during normal operation of the piping inside the industrial facility that is a target of the abnormal noise detection performed by the unmanned aerial vehicle based abnormal noise detection device 1. The normal operation may mean a case where no abnormal state occurs in the piping.

In some embodiments, the first frequency band range may include a first sub-frequency band and a second sub-frequency band. The first sub-frequency band and the second sub-frequency band may be frequency bands having different ranges from each other.

The flight path control module 330 may control the path along which the drone 100 flies. For example, the flight path control module 330 may control the drone 100 so that the drone 100 flies along a preset flight path. In another example, the flight path control module 330 may control the drone 100 to change the flight path during flight.

The flight path control module 330 may switch the flight path of the drone 100 depending on the mode. In the case of a manual mode, the flight path control module 330 may allow the drone 100 to fly according to an external input. At this time, the external input may include a case where a command is provided from the host in response to a user input.

In the case of an automatic mode, the flight path control module 330 may control the drone 100 to fly around a point on which a sound of a specific frequency band is generated without an external input, on the basis of the acoustic data generated by the acoustic sensor 200.

For example, the flight path control module 330 may grasp the position at which the acoustic sensor 200 detects the sound of a specific frequency band, and set the flight path of the drone 100 so that the drone 100 operates on the basis of that position.

The radio communication module 340 may provide the visualized image 410 generated by the data processing module 310 to the display 400.

The processor 350 may perform the overall calculation required in the unmanned aerial vehicle based abnormal noise detection device 1.

The memory 360 may store data necessary for the operation of the unmanned aerial vehicle based abnormal noise detection device 1. The memory 360 may store the acoustic data measured by the acoustic sensor 200. The memory 360 may store a preset flight path along which the flight path control module 330 controls the drone 100 to fly. The memory 360 may store a machine learning model used by the machine learning module 320. The memory 360 may store various types of data used by the machine learning module 320 for machine learning.

The display 400 may output the visualized image 410 generated by the data processing module 310. The display 400 may be provided with the visualized image 410 from the radio communication module 340.

The visualized image 410 that is output by the display 400 may visually represent position information about filtered abnormal acoustic data (FASD) detected and generated by being filtered by the acoustic sensor 200. This will be described in detail with reference to FIGS. 5 to 16.

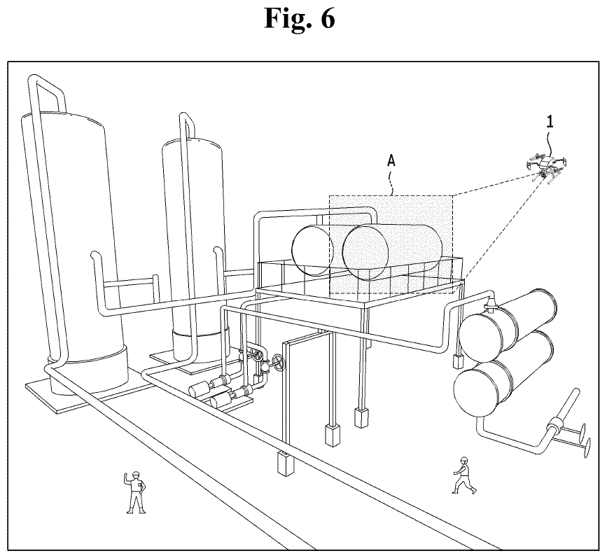

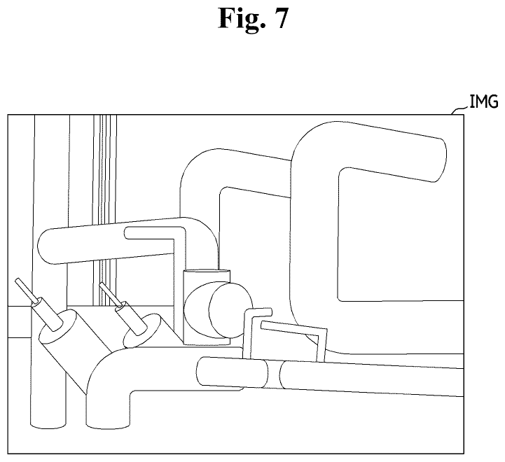

FIG. 5 is a flowchart for explaining the operation of an unmanned aerial vehicle based abnormal noise detection device according to some embodiments of the present disclosure. FIG. 6 is a flowchart for explaining the visualized image generation process of FIG. 5. FIG. 7 is an exemplary diagram for explaining the operation of the unmanned aerial vehicle based abnormal noise detection device according to some embodiments of the present disclosure. FIG. 7 is an exemplary diagram for explaining a leakage detection operation for a region A of FIG. 6.

Referring to FIGS. 5 and 6, the unmanned aerial vehicle based abnormal noise detection device 1 may fly and locate on the measurement target (S510). In some embodiments, the measurement target may correspond to an industrial facility located on a high-altitude area. By detecting leakage of the industrial facility located on high-altitude areas using the unmanned aerial vehicle based abnormal noise detection device 1, a leakage detection and diagnosis method with improved safety and efficiency in terms of time and cost may be provided.

In some embodiments, the unmanned aerial vehicle based abnormal noise detection device 1 may perform the machine learning of a frequency band for classifying abnormal acoustic data while flying around the measurement target (S520). For example, the machine learning module 320 may determine a first frequency band range by the acoustic data collected while the drone 100 is flying. In some embodiments, the first frequency band range may be a frequency band range of acoustic data collected by the acoustic sensor 200 when no abnormal noise occurs in the measurement target.

In some embodiments, the unmanned aerial vehicle based abnormal noise detection device 1 may measure the acoustic data and image data of the measurement target while flying (S530). For example, the acoustic sensor 200 in the unmanned aerial vehicle based abnormal noise detection device 1 may measure acoustic data generated from the measurement target in an region A at a certain time, and transmit it to the controller 300. Further, the camera 220 in the unmanned aerial vehicle based abnormal noise detection device 1 may capture an image of a measurement target in the region A to generate image data IMG and transmit the image data IMG to the controller 300.

A specific method for detecting leakage for the region A will be described below.

Referring to FIGS. 5 and 7, the data processing module 310 included in the controller 300 may be provided with the image data IMG measured from the camera 220. The data processing module 310 may form a matrix on the image data IMG that divides the image data IMG into certain cell units.

In some embodiments, the size of the matrix may be equal to or larger than the size of the image data IMG. For example, the matrix may be a matrix of the form a×b. Both a and b may be natural numbers. However, the embodiment of the present disclosure is not limited thereto, and the form of the matrix may be changed.

Referring to FIG. 5, the data processing module 310 may generate object data that is included in the image data IMG and represent the size and position of an object that is a target of abnormal noise detection. The object that is the target of the abnormal noise detection may correspond to the measurement target in region A.

In some embodiments, the data processing module 310 may detect an object that is a target of the abnormal noise detection in the image data IMG. For example, the object may be piping in the industrial facility.

The data processing module 310 may classify the abnormal acoustic data from the acoustic data provided from the acoustic sensor 200. For example, the acoustic sensor 200 may provide the data processing module 310 with acoustic data corresponding to the position of each cell in the matrix. Further, the data processing module 310 may classify acoustic data that is not included in the first frequency band range as abnormal acoustic data.

The data processing module 310 may remove noise from the abnormal acoustic data.

In some embodiments, the abnormal acoustic data may include a first noise and a second noise. The first noise may include the abnormal acoustic data generated outside the object among the abnormal acoustic data. For example, when the unmanned aerial vehicle based abnormal noise detection device 1 flies, environmental noise generated in the environment outside the object may be detected by the acoustic sensor 200, and included in the abnormal acoustic data. That is, the first noise may be abnormal acoustic data that does not overlap the object data.

The second noise may include abnormal acoustic data that corresponds to abnormal acoustic data generated in the object among the abnormal acoustic data, but is not abnormal acoustic data due to an abnormal state of the object. For example, the abnormal state that may occur in the object may be a gas leakage in the piping, a crack that occurs in the piping, an electric arc or the like. That is, the second noise may mean abnormal sound data, that is not abnormal sound data due to an abnormal state of the object, such as a gas leakage in the piping, a crack that occurs in the piping or an electric arc.

Referring to FIG. 4, the data processing module 310 may generate a visualized image 410 obtained by superimposing the (FASD) on the image data IMG, and display the visualized image on the display.

The visualized image 410 may display the positions of the first abnormal sound data and the second abnormal sound data generated by different abnormal states, in a distinguished manner. As a result, the user may accurately grasp the position of the abnormal noise generated by the abnormal state of the object through the visualized image 410 displayed on the display 400. In addition, abnormal noises according to the plurality of abnormal states may be easily distinguished. When this is applied to the industrial facility located on a high-altitude area, a leakage detection and diagnosis method with improved stability and efficiency in terms of time and cost may be provided.

Although the embodiments of the present disclosure have been described above with reference to the accompanying drawings, the present disclosure is not limited to the above embodiments, and may be fabricated in various different forms. Those skilled in the art will appreciate that the present disclosure may be embodied in other specific forms without changing the technical spirit or essential features of the present disclosure. Accordingly, the above-described embodiments should be understood in all respects as illustrative and not restrictive.

What is claimed is:

1. A method for operating an unmanned aerial vehicle based abnormal noise detection device, the method comprising:
capturing, using a camera attached to a drone to generate image data, an image of a measurement target included in the image data;
generating, based on the captured image, a matrix comprising a plurality of cells on the image data;
generating object data of an object corresponding to the measurement target included in the image data, the object data indicating a size and a position of the object that is a target of an abnormal noise detection;
collecting, using an acoustic sensor attached to the drone, acoustic data corresponding to each of the plurality of cells;
classifying, using the collected acoustic data, abnormal acoustic data depending on a frequency of the acoustic data;
generating filtered abnormal acoustic data using the abnormal acoustic data and the object data; and
generating a visualized image in which positions of cells including the filtered abnormal acoustic data are displayed on the image data.

2. The method for operating the unmanned aerial vehicle based abnormal noise detection device of claim 1,
wherein the abnormal acoustic data is not included in a first frequency band range in which the frequency of the acoustic data is preset, and
the first frequency band range is a range of the acoustic data measured during normal operation of the object.

3. The method for operating the unmanned aerial vehicle based abnormal noise detection device of claim 2,
wherein the generation of the filtered abnormal acoustic data includes a removal, from the abnormal acoustic data, of noise that is not the abnormal acoustic data generated by an abnormal state of the object.

4. The method for operating the unmanned aerial vehicle based abnormal noise detection device of claim 3,
wherein the noise comprises:
a first noise, which is abnormal acoustic data included outside the object data, among the abnormal acoustic data, and
a second noise, which is the abnormal acoustic data not generated by the abnormal state of the object, among the abnormal acoustic data from which the first noise is removed.

5. The method for operating the unmanned aerial vehicle based abnormal noise detection device of claim 2,
wherein the first frequency band includes a first sub-frequency band and a second sub-frequency band having different ranges from each other.

6. The method for operating the unmanned aerial vehicle based abnormal noise detection device of claim 1, further comprising:
providing the visualized image to a display by a radio communication module, and
displaying the visualized image by the display.

7. The method for operating the unmanned aerial vehicle based abnormal noise detection device of claim 1,
wherein a size of the image data is smaller than or equal to a size of the matrix.

8. An unmanned aerial vehicle based abnormal noise detection device comprising:
a drone;
an acoustic sensor attached to the drone and configured to collect acoustic data using a beam-forming technology;
a camera attached to the acoustic sensor, the camera configured generate image data that includes an image of a measurement target;
a controller which generates a visualized image, using the image data and the acoustic data; and
a display which displays the visualized image,
wherein the controller is configured to:
generate a matrix including a plurality of cells on the image data and larger than or equal to the size of the image data,
generate object data of an object corresponding to the measurement target included in the image data, the object data indicating a size and a position of the object that is a target of an abnormal noise detection,
classify acoustic data that is not included in a preset first frequency band range from the acoustic data corresponding to each cell to generate abnormal acoustic data,
generate, using the abnormal acoustic data and the object data, filtered abnormal acoustic data, and
generate a visualized image in which positions of cells including the filtered abnormal acoustic data are displayed on the image data,
wherein the first frequency band range is a range of the acoustic data measured during normal operation of the object.

9. The unmanned aerial vehicle based abnormal noise detection device of claim 8,
wherein the generation of the filtered abnormal acoustic data includes a removal, from the abnormal acoustic data, of noise that is not the abnormal acoustic data generated by an abnormal state of the object.

10. The unmanned aerial vehicle based abnormal noise detection device of claim 9,
wherein the noise comprises:
a first noise, which is abnormal acoustic data included outside the object data, among the abnormal acoustic data, and
a second noise, which is the abnormal acoustic data not generated by the abnormal state of the object, among the abnormal acoustic data from which the first noise is removed

11. The unmanned aerial vehicle based abnormal noise detection device of claim 8, further comprising:
a radio communication module that provides the visualized image to the display.

12. A method for operating an unmanned aerial vehicle based abnormal noise detection device, the method comprising:
capturing, to generate image data with a camera attached to a drone, an image of a measurement target included in the image data ;
generating, based on the captured image, a matrix including a plurality of cells on the image data and corresponding to a size of the image data;
generating object data of an object corresponding to the measurement target included in the image data, the object data indicating a size and a position of the object that is a target of an abnormal noise detection;
collecting acoustic data corresponding to each of the plurality of cells by an acoustic sensor attached to the drone;
classifying, using the collected acoustic data, acoustic data that is not included in a preset first frequency band range from the acoustic data to generate abnormal acoustic data;
removing noise that is not abnormal acoustic data due to an abnormal state of the object from the abnormal acoustic data to generate filtered abnormal acoustic data;
generating visualized image in which positions of cells that include the filtered abnormal acoustic data are displayed in the image data;
providing the visualized image to a display by a radio communication module; and
displaying the visualized image by the display.
